(19) United States
(12) Patent Application Publication
(10) Pub. No.: US 2018/0153193 A1
(43) Pub. Date: Jun. 7, 2018

(54) METHOD AND SYSTEM FOR MAKING CARBONATED PROTEIN BEVERAGE COMPOSITIONS

(71) Applicant: NEXT Proteins, Inc., Carlsbad, CA (US)

(72) Inventor: David A. Jenkins, Carlsbad, CA (US)

(21) Appl. No.: 15/573,406

(22) PCT Filed: May 10, 2016
(86) PCT No.: PCT/US16/31599

§ 371 Date: Nov. 10, 2017

Related U.S. Application Data
(60) Provisional application No. 62/159,895, filed on May 11, 2015.

(51) Int. Cl. A23L 2/66; A23L 2/54; B01F 15/00; B01F 3/08; B01F 7/00; B01F 3/04; B01F 15/06

(52) U.S. Cl. CPC A23L 2/66; A23V 2002/00; B01F 15/00175; B01F 15/00396; B01F 3/0853; B01F 7/00633; B01F 7/0025; B01F 7/00975; B01F 3/04815; B01F 15/063; B01F 2003/049; B01F 2003/04879; B01F 2003/04921; B01F 2015/062; B01F 2215/0022; A23L 2/54

(57) ABSTRACT

A method according to an embodiment may be used to make a carbonated protein beverage composition for large quantity mass production purposes. The method includes flowing a liquid protein concentrate and water, and mixing them to form a beverage composition pre-mix. The temperature of the pre-mix is sensed, and the water temperature of the water prior to mixing with the flowing protein concentrate is controlled to maintain a substantially constant temperature of the beverage composition pre-mix. Carbonation is added to the temperature controlled pre-mix to form the carbonated protein beverage composition, which is then containerized.

### RELATED APPLICATION

This application claims priority to U.S. provisional patent application, entitled METHOD AND SYSTEM FOR MAKING CARBONATED PROTEIN BEVERAGE COMPOSITIONS, Application No. 62/159,895, filed May 11, 2015, and incorporates by reference the U.S. provisional patent application in its entirety.

### FIELD OF THE INVENTION

The present invention relates in general to a method and system for making carbonated protein beverage compositions. It more particularly relates to such a method and system for making carbonated protein beverage compositions on a large scale mass production basis.

### BACKGROUND OF THE INVENTION

There is no admission that the background art disclosed in this section legally constitutes prior art.

Protein carbonated beverages have been known to be highly desirable and marketable. They are not only healthy to drink, but also such protein containing beverages are very desirable for their pleasant taste and mouth feel. For example, reference may be made to the following U.S. Pat. Nos. 7,205,018 B2; 7,794,770 B2; 7,799,363 B2; 7,842,326 B2; 7,897,192 B2; and 7,906,160 B2; and U.S. patent application Ser. No. 14/259,097, filed Apr. 22, 2014, all of which are incorporated herein by reference.

Such patented carbonated protein beverages also have been discovered to possess a very long unrefrigerated shelf life where cans and bottles of such carbonated protein beverages are capable of remaining in an unrefrigerated state for more than one year and still retain its drinkability. In this regard, even after such a long period of unrefrigerated shelf life, such as one year, the patented carbonated protein beverages are capable of being essentially free of active microbes known to be harmful to human health without the need for any thermal processing to inactivate microbes. Furthermore, the flavor is retained as well as mouth feel in a consistent manner. Also, the carbonation is able to be retained in a desirable and consistent manner even after one year or more of unrefrigerated shelf life.

The patented carbonated protein beverage compositions are stable and are consistent in taste and mouth feel by having the composition include, amongst other things, critical ranges of quantities of certain ingredients to achieve such remarkable results. Such ingredient ranges may include pH ranges and carbonation ranges.

In order to scale up for the mass production of such carbonated protein beverages, it would be necessary to produce cans or bottles of such carbonated beverages at an extremely high rate of throughput such as about 1000 cans or bottles per minute or more. However, to be able to achieve such a production rate effectively and still retain consistent taste, mouth feel and a desirable amount of carbonation retention for the beverage compositions, there are a number of significant and complex processing problems which may be encountered.

The problems associated with such a large scale mass production process of making protein beverage compositions may include, heat variations in the protein product being manufactured causing a significant change in the pH of the protein, which is critical for achieving the desired taste and mouth feel as well as other critical aspects of the beverage. The heat changes may be primarily caused by changes in the ambient temperature at the manufacturing facility. Such changes in ambient temperature may occur during the same day of a given production run, and/or may also vary from one geographical location to the next.

Furthermore, the amount of carbonation is directly and adversely affected by temperature change. The amount of carbonation has proven to be critical, and if there is a variation during the day, for example, the taste and shelf life of the product can be adversely affected. Also, when a container such as a can of carbonated protein beverage is chilled to a normal desired drinking temperature, temperature changes during production of the beverage may cause the taste and mouth feel of the product to change to an unwanted and undesirable manner. For example, the pH of the beverage may change, and the critical amount of carbonation gas or gases may not be achievable.

The bubble size and the retention of the bubbles are important to the taste and mouth feel of the finished product. Moreover, the bubble size and retention are directly dependent upon temperature changes in the environment during production. In this regard, for a carbonated protein beverage, it may be undesirable to have foaming occur during production as well as when a can or bottle of the carbonated protein beverage is opened in preparation for consuming the contents thereof. When the bottle or can is first opened, it is highly desirable to have only a short duration of fizzing to occur. Then, when the beverage is being consumed, it is highly desirable to have a pleasant sensation in the mouth from small refined bubbles. For this purpose, it is desirable to have small bubbles present in the carbonated protein beverage and be retained in the beverage during consumption to provide the desired mouth feel and taste with little or no unwanted foaming or fizzing.

Beverages such as beer and soft drinks are carbonated according to known techniques. For example, reference may be made to prior known techniques as follows: CN 103892387A; EP 001518461; EP 045779461; EP 0812544A2, EP 250944361; ES 214342561; GB 1166338A; SU 993907A1; U.S. Pat. No. 3,996,391A, U.S. Pat. No. 4,656,044A, U.S. Pat. No. 4,716,046A, US70336341B2, US71478821B2, US77947701B2, US79061601B2, US85630671B2, US86971621B2, U.S. Pat. No. 8,778,418, U.S. Pat. No. 8,985,396, US20080248181A1, US20110159165A1, US20120128832A1, US20120282370A1, US20130273199A1, US20140234488A1, US20150050413A1, WO2009112036A2; WO2012054203A1; WO2013049540A2; and WO2014210326A2.

Also, the following are non-patent published articles:

Ravindra M R, Rao K J, Nath B S, Ram C., “EXTENDED SHELF LIFE FLAVOURED DAIRY DRINK USING
DISSOLVED CARBON DIOXIDE”, J Food Sci Technol. 2014 January; 51(1): 130-5.
Y Ma, Barbano D M, Santos M., “EFFECT OF CO(2) ADDITION TO RAW MILK ON PROTEOLYSIS AND
LIPOLYSIS AT 4[DEGREES] C1”, Source: Journal of Dairy Science 86.5 (May 2003): 1616-1631.
Syed, J; Chadwick, R G, “A LABORATORY INVESTIGATION OF CONSUMER ADDITION OF UHT MILK TO
LESSEN THE EROSIVE POTENTIAL OF FIZZY DRINKS”, Source: British Dental Journal 206.3 (Feb. 14, 2009):
E6; discussion 154-5.
Suresh K. B., Jayaprakasha H. M., “PROCESS OPTIMIZATION FOR PREPARATION OF BEVERAGE FROM
LACTOSE HYDROLYZED WHEY PERMEATE”, Journal of Food Science and Technology, v 41, n 1, p 27-32,
January/February 2004.
Walsh H, Cheng J, Guo M., “EFFECTS OF CARBONATION ON PROBIOTIC SURVIVABILITY,
PHYSICOCHEMICAL, AND SENSORY PROPERTIES OF MILK-BASED SYMBIOTIC BEVERAGES”, J Food Sci.
2014 April; 79(4): M604-13.
Walsh, Helen, “FUNCTIONAL PROPERTIES OF WHEY PROTEIN AND ITS APPLICATION IN
NANOCOMPOSITE MATERIALS AND FUNCTIONAL FOODS”, The University of Vermont and State
Agricultural College, ProQuest, UMI Dissertations Publishing, 2014. 3629079.
Ahmed Z, Wang Y, Ahmad A, Khan S T, Nisa M, Ahmad H, Afreen A., “KEFIR AND HEALTH: A
CONTEMPORARY PERSPECTIVE”, Crit Rev Food Sci Nutr. 2013; 53(5): 422-34. doi: 10.1080/
10408398.2010.540360.
M. Mazaheri AssadiView Profile; Abdolmaleki, F; Mokarrame, R R., “APPLICATION OF WHEY IN
FERMENTED BEVERAGE PRODUCTION USING KEFIR STARTER CULTURE”, Nutrition and Food Science
38.2(2008): 121-127.
Tomczyska-Mleko M, “NEW PRODUCT DEVELOPMENT: CARBONATED BEVERAGE WITH
DIFFERENT PROTEIN AND CREATINE FOR SPORTSMEN AND PHYSICALLY ACTIVE PEOPLE”, Agro Food
Industry Hi-Tech. 2014 Sep. 1; 25(5): 53-6.
Li, Ning; Wang, Xue-Jing; Xu, Li-Qiang; Zhang, Hui-Yan, “DEVELOPMENT OF A NEW BEVERAGE OF APPLE
MILK BEER”, Source: Shipin Keji (Food Science and Technology) 6 (2008): 53-55.
Rostoks L, “HOT STUFF FOR 2002”, Source: Canadian Grocer 116.1 (February 2002): 9.
“WHEY DRINK TO GO IN GERMANY”, Source: Dairy Industries International 77.9 (September 2012): 12.
“COCA-COLA PREPARES TO LAUNCH VIO IN NY”, Source: Dairy Industries International 74.10 (October 2009):
10.
“SPARKLING, FUNCTIONAL YOGURT DRINKS”, Source: Dairy Foods 99.1 (January 1998): 42.
“NEW PRODUCT REVIEW”, Source: Dairy Foods 110.9 (September 2009): 24-25.
James Meikle, “COCA-COLA TRIALS SWEET, FIZZY, MILKY ‘VIBRANCY’ DRINK IN THREE US CITIES”,
Source: The Guardian Monday 27 Jul. 2009 14.44 BST.
“GOOD MOOS”, Source: Dairy Farmer (May 1, 2001): 33.
“A HEALTHY APPROACH”, Source: Food Manufacture (Aug. 1, 1998): 18.
“THE COMEBACK KID”, Source: Canning, Kathie. Dairy Field 186.9 (September 2003): 71.
“WHEY DRINKS BOOM”, Source: Dairy Industries International 68.9 (September 2003): 7.
“CUCKOOS IN THE NEST?”, Source: Dairy Industries International 68.3 (March 2003): 3.
G. S. Barker, B. Jefferson, S. J. Judd, “THE CONTROL OF BUBBLE SIZE IN CARBONATED BEVERAGES”,
Source: Chemical Engineering Science, 57 (2002) 565-573.
G. S. Barker, B. Jefferson, S. J. Judd, “DOMESTIC CARBONATION PROCESS OPTIMISATION”, Source:
Journal of Food Engineering, 52 (2002) 405-412.
Charles Descoins, Mohamed Mathlouthi, Michael Le Moual, James Hennequin, “CARBONATION
MONITORING OF BEVERAGE IN A LABORATORY SCALE UNIT WITH ON-LINE MEASUREMENT OF
DISSOLVED CO₂”, Source: Food Chemistry, 95 (2006) 541-553.

It is known to carbonate beer in such a manner that the resulting carbonated beer foams when it is poured into a glass to form a foamy head. To provide such foaming to occur, stabilizers are added to the beer composition during its production phase. However, such stabilizers are not at all desirable for carbonated protein beverages since it is unwanted and undesirable to have such a protein beverage produce a foamy head when poured. Also, the addition of stabilizers adds an unwanted and unnecessary expense to the product.

Many soft drinks are carbonated in such a manner as to avoid a foaming product. Instead, it is considered desirable for soft drinks to achieve substantial fizzing when the bottle or can is first opened. Such fizzing is accomplished by introducing the carbonation under high pressure and the use of large size bubbles which cause the substantial fizzing to occur. But neither the large-size bubbles nor substantial fizzing is desired for a carbonated protein product.

Therefore, it would be highly desirable to have a new and improved mass production process for a carbonated protein beverage where the ambient temperatures have little or no adverse affect on the production of the product. Also, the bubble size and bubble retention can be controlled effectively and efficiently so that a consistent product can be achieved with an extremely long shelf life such as one year or more. Also, there should be no need for the use of expensive and complex equipment for controlling bubble size.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1 is a symbolic block diagram of a carbonated protein beverage composition making system which may be made according to an embodiment;

FIG. 2 is a diagrammatic partially broken away plan view of a mixing tank of the system of FIG. 1;

FIG. 3 is a diagrammatic bottom plan view of the manifold of FIG. 2; and

FIGS. 4-7 are flow chart diagrams of methods according to various embodiments.

### DETAILED DESCRIPTION OF CERTAIN EMBODIMENTS OF THE INVENTION

Certain embodiments of the present invention will now be described more fully hereinafter with reference to the accompanying drawings, in which some, but not all, embodiments of the invention are shown. Indeed, these embodiments of the invention may be in many different forms and thus the invention should not be construed as limited to the embodiments set forth herein; rather, these embodiments are provided as illustrative examples only so that this disclosure will satisfy applicable legal requirements. Like numbers refer to like elements throughout.

It will be readily understood that the components of the embodiments as generally described and illustrated in the drawings herein, could be arranged and designed in a wide variety of different configurations. Thus, the following more detailed description of the certain ones of the embodiments of the apparatus system, components and methods of the present invention, as represented in the drawings, is not intended to limit the scope of the invention, as claimed, but is merely representative examples of one or more of the embodiments of the invention.

A method according to an embodiment may be used to make a carbonated protein beverage composition for large quantity mass production purposes. The method includes flowing a liquid protein concentrate and water, and mixing them to form a beverage composition pre-mix. The temperature of the pre-mix is sensed, and the water temperature of the water prior to mixing with the flowing protein concentrate is controlled to maintain a substantially constant temperature of the beverage composition pre-mix. Carbonation is added to the temperature controlled pre-mix to form the carbonated protein beverage composition, which is then containerized.

Another embodiment of the method relates to mixing flowing liquid protein concentrate and water to form a beverage composition pre-mix. The pH of the pre-mix is sensed, and the pH of the pre-mix is controlled in response to the sensed pH being out of a given pH range. Carbonation is added to the pre-mix to form the carbonated protein beverage composition, which is then containerized.

A further embodiment of the method relates to mixing flowing liquid protein concentrate and water to form a beverage composition pre-mix. The quantity of protein in the pre-mix is sensed, and the quantity of the flowing liquid protein concentrate mixing with the flowing water is controlled in response to the sensed protein being out of a given protein range. Carbonation is added to the pre-mix to form the carbonated protein beverage composition, which is then containerized.

Yet another embodiment of the method relates to mixing flowing liquid protein concentrate and water to form a beverage composition pre-mix. The hardness of the flowing water is sensed. The hardness of the flowing water is controlled in response to the sensed hardness being out of a given hardness range. Carbonation is added to the pre-mix to form the carbonated protein beverage composition, which is then containerized.

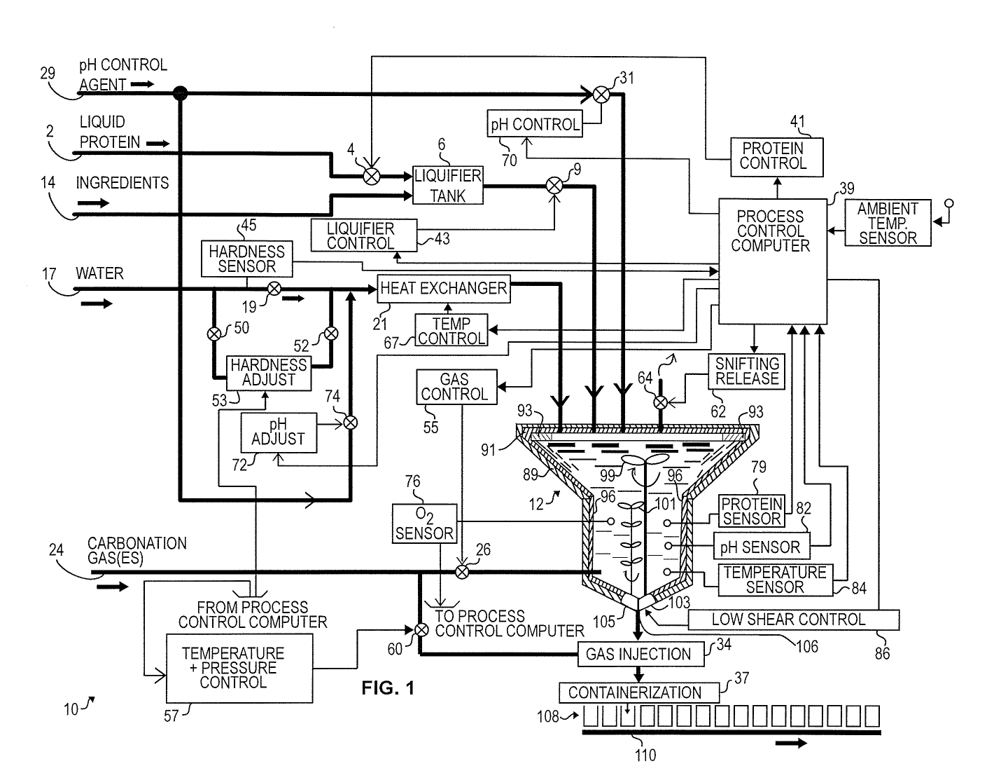

Referring now to the drawings, and more particularly to FIGS. 1-3 thereof, a system 10 for making carbonated protein beverage compositions may be constructed according to an embodiment. The system 10 enables the flowing of a liquid protein concentrate at 2 under pressure through a valve 4 into a liquifier tank 6, and then through valve 9 into a mixing tank 12. The liquid protein concentrate may comprise a syrup and may have a weight percentage from about 20% to about 22%. Water at 17 flows under pressure through valve 19 into a heat exchanger 21 and then into the tank 12 for mixing with the flowing liquid protein concentrate to form a beverage composition pre-mix. The temperature of the pre-mix is monitored in the tank 12 and can be controlled by adjusting the water temperature in the heat exchanger 21 prior to mixing with the flowing liquid protein concentrate. The beverage composition pre-mix may be kept at a substantially constant temperature between about 2° C. and about 5° C. The flowing liquid components such as the liquid protein concentrate and water may flow under the force of gravity, or may be pumped by pumps (not shown).

After the temperature controlled beverage composition pre-mix is created in the tank 12, carbonated gas flows through valve 60 and is admixed to the pre-mix at gas injection 34 to form a carbonated protein beverage composition. At a final stage, the carbonated protein beverage composition may be containerized at containerization 37 into one or more containers 108 along a conveyor belt 110. It should be understood that the resulting carbonated protein beverage composition may be in the form of a beverage, or in the form of a syrup which can be reconstituted at another location. The syrup can be 2 to 5 fold.

A pH control agent at 29 flows through valve 31 into the tank 12 where it is admixed with the beverage composition and water for controlling the pH level of the final carbonated protein beverage composition. In an embodiment, the carbonated protein beverage composition may have a pH level between about 2.0 and about 4.6, and preferably between about 2.8 and about 3.1.

In an embodiment, various ingredients at 14 may flow under pressure such as by a pump (not shown) into the liquefier tank 6 for admixing with the liquid protein concentrate flowing therethrough. It should be understood that solid ingredients may be admixed as well in accordance with known techniques. The ingredients may include at least one additional ingredient selected from the group consisting of an anti-foaming agent, a nutrient, calcium or a calcium derivative, hyperimmune milk protein, and herbal supplement, a flavoring agent, a sweetener, a coloring agent, alcohol, a preservative, and an energy-generating additive selected from the group consisting of caffeine, magnesium, and citrulline malate.

In order to mix the flowing liquids in the tank 12, the presence of protein can cause unwanted frothing to occur. Thus, it has been discovered that the liquids flowing into the tank 12 must be done so in a gentle manner to avoid shearing. A manifold at the top of the tank and inwardly tapered side walls assist in the avoidance of foaming. Also dual mixing paddles are employed.

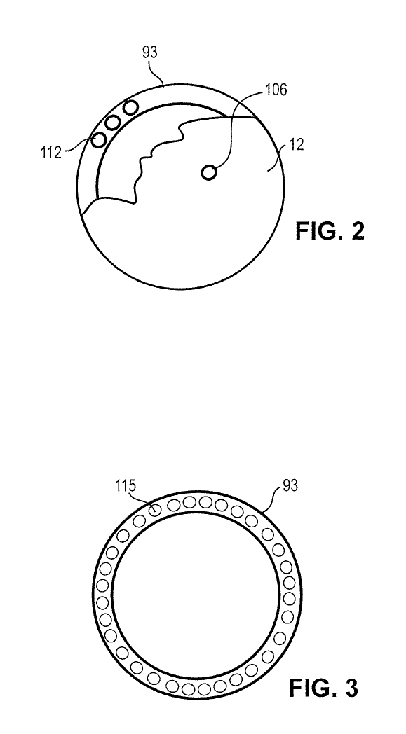

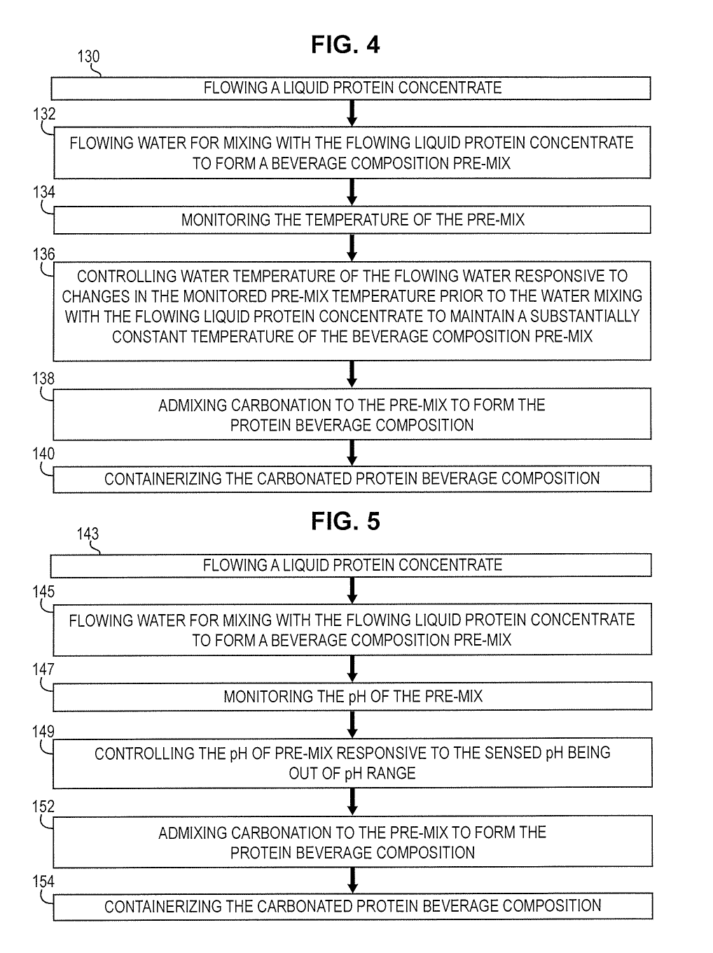

For the mixing process to occur continuously in the tank 12, the liquid protein concentrate, the water, the ingredients and the pH control agent 29 flow into a manifold 93 at the top of the tank 12. As shown in FIGS. 2-3, manifold 93 may be an annular tube-shaped manifold that is horizontally positioned near the top of the tank 12 and has a hollow interior. The annular shape of the manifold 93 substantially conforms to the shape of an inner wall 96 of the tank 12. In this regard, the tank 12 is generally circular in cross section throughout its height, and the manifold is generally circular in plain view. Manifold 93 includes a number of openings on both its bottom and top portions. For example, and as shown in a top view of the manifold 93 in FIG. 2, the bottom portion of the manifold 93 includes at least three inlet openings generally indicated at 112. And as shown in a bottom view of the manifold 93 in FIG. 3, the bottom wall portion of the manifold 93 includes many openings such as opening 115. The exact number and size of the bottom outlet openings in the manifold 93 may vary depending upon various factors such as the type of constituents that are being mixed and the desired flow rates.

The tank 12 also includes low speed paddles 99 and high speed mixer 101. The low speed mixing paddles 99 is driven by a low speed motor 103 and the high speed mixing paddles 101 is driven by a high speed motor 105. At least a portion of the inner wall 96 is located on an upper frustoconical section or portion of the tank 12 and slopes downward and inwardly. The upper section receives the flowing liquids exiting from the outlets of the manifold onto or near the inner wall to avoid foaming. This upper section confines the low speed mixing paddles, and the lower smaller diameter section confines the higher speed mixing paddles. The tank 12 may also include an outer wall insulation layer 89 that insulates the inside of the tank 12 to help insure consistent temperature control during the mixing process. The tank 12 may include an outlet opening 106 located at the bottom thereof.

Initially, the liquid protein concentrate, the water, the ingredients and the pH control agent flow gently from the bottom outlet openings such as the opening 115 in the top portion of the manifold 93 in order to begin gentle mixing. The annular manifold 93 is positioned near the inner wall 96 of the tank 12, and the pre-mix slowly descends down along the sloping inner wall 96 of the tank 12 while being further mixed by the motion of the low speed mixing paddles 99 in a swirling manner. The pre-mix then continues to descend in the tank 12 where it is further mixed by the high speed mixing paddles 101. After the pre-mix is substantially mixed, the pre-mix exits the tank 12 through a bottom outlet opening 106 into the gas injection 34 where carbonation gas or gases are injected into the protein beverage composition to carbonate the pre-mix. The carbonation may be in the form of a combination of oxygen and nitrogen. The concentration may be 90% oxygen and 10% nitrogen, or as much as 50% oxygen and 50% nitrogen.

The operation of the protein beverage making system 10 is controlled by a process control computer 39, which receives inputs and provides outputs relating to various factors in the system 10.

The process control computer 39 senses the amount of protein in the beverage composition pre-mix in the tank 12 from protein sensor 79. Based on the sensed amount of protein, the computer 39 controls through a protein control 41 coupled to valve 4 the amount of liquid protein concentrate 2 that is flowed to the liquifier tank 6 for admixing with the ingredients 14. The computer 39 then controls through a liquifier control 43 coupled to the valve 9 the amount of liquid protein concentrate 2 and mixed ingredients 14 that is flowed into the mixing tank 12.

The computer 39 senses the pH level of the pre-mix through a pH sensor 82 located in the tank 12. Based on the sensed pH level, the computer 39 controls the amount of the pH control agent 29 that is admixed into the beverage composition pre-mix to control the pH level of the carbonated protein beverage composition through a pH control 70 coupled to valve 31. In addition, the computer 39 controls the pH level of the water 17 through a pH adjust 72 and valve 74 prior to the water 17 flowing into the heat exchanger 21.

The computer 39 senses the temperature of the pre-mix through a temperature sensor 84 in the tank 12. Based on the sensed temperature of the pre-mix, the computer 39 controls the temperature of the water 17 through a temperature control 67 coupled to the heat exchanger 21. In addition, the computer 39 controls the temperature and the pressure of the carbonation gas 24 through a temperature and pressure control 57 coupled to valve 60.

The computer 39 senses the O₂ level of the pre-mix through an O₂ sensor 76 located in the tank 12. Based on the O₂ level of the pre-mix, the computer 39 controls the amount of carbonation gas 24 that is flowed into the tank 12 through valve 26. In addition, computer 39 controls the amount of excess O₂ located within the tank 12 that is released by a snifting release 62 through a snifting valve 64 to remove O₂ from the tank 12.

The computer 39 senses the hardness level of the water 17 through a hardness sensor 45 for sensing the water 17 hardness before it flows into the heat exchanger 21. Based on the hardness level, the computer 39 controls the hardness of the water 17 through a hardness adjust 53 coupled through valve 50 and valve 52.

The computer 39 controls the shearing amount of the pre-mix/protein beverage composition through a low shear control 86.

Method of Making a Carbonated Protein Beverage

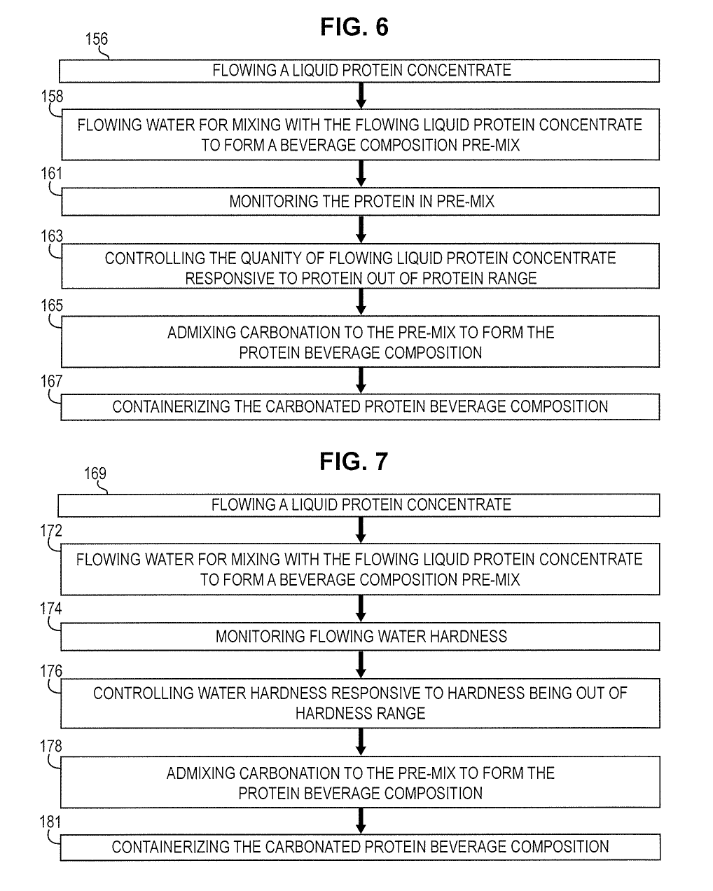

Referring now to FIG. 4, there is shown a method of making a carbonated protein beverage composition where variation in temperature changes in the pre-mix are compensated dynamically for as the process continues. As a result, bubble size and retention are controlled for the resulting product. Referring to boxes 130 and 132, the method includes the steps of flowing a liquid protein concentrate and flowing water for mixing with the flowing liquid protein concentrate to form a beverage composition pre-mix. At boxes 134 and 136, the temperature of the pre-mix is monitored, and the water temperature of the flowing water is controlled responsive to changes in the monitored pre-mix temperature prior to the water mixing with the flowing liquid protein concentrate to maintain a substantially constant temperature of the beverage composition pre-mix at the critical range of between about 4° C. and about 5° C. At box 138, carbonation is admixed with the temperature controlled pre-mix to form the carbonated protein beverage composition. At box 140, the carbonated protein beverage composition is containerized.

As shown in FIG. 5, a method of making a carbonated protein beverage composition is shown where variations in pH of the pre-mix is compensated for dynamically as the process progresses. The resulting protein beverage composition contains a pH within a critical range of 2.0 to 5.5.

As shown in boxes 143 and 145, flowing liquid protein concentrate and water are mixed to form the pre-mix. In boxes 147 and 149, the pH of the pre-mix is monitored, and the pH of the pre-mix is controlled responses to the sensed pH being out of a critical pH range of between about 2.0 and about 4.6, or more preferably between about 2.8 and about 3.1. These critical ranges and then discovered as mentioned in the foregoing patents disclosing carbonated protein beverages possessing remarkably long unrefrigerated shelf lives. Boxes 152 and 154 disclose the admixing of carbonation, followed by containerization of the carbonated protein beverage composition.

As shown in FIG. 6, there is shown a method for making a carbonated protein beverage composition whereby the amount of protein in the final beverage composition is maintained in the critical range of between about 0.01% by weight to about 15% by weight protein.

As shown in boxes 156 in 158, flowing liquid protein concentrate and flowing water are mixed to form the pre-mix. In box 161, the protein content of the premix is sensed continuously. In box 163, the quantity of the flowing liquid protein concentrate is adjusted in response to the protein being out of the critical protein range. In this manner, the final product is consistently and effectively maintained within the critical range of protein. In boxes 165 and 167, the pre-mix is carbonated, and containerized.

Referring now to FIG. 7, there is shown a method of making a carbonated protein beverage composition wherein the hardness of the flowing water is continuously monitored and adjusted within a given critical desired range. In so doing, the taste and mouth feel are controlled in the resulting product, and also the critical pH thereof.

In boxes 169 and 172, the flowing liquid protein concentrate and water are mixed. The water hardness is continuously sensed as indicated in box 174. In box 176, the water hardness of the flowing water is adjusted prior to being mixed with the flowing liquid protein concentrate to adjust the hardness when the water hardness is sensed to be out of the desired hardness range. In boxes 178 and 181, the pre-mix is carbonated and containerized.

Although the invention has been described with reference to the above examples, it will be understood that many modifications and variations are contemplated within the true spirit and scope of the embodiments as disclosed herein. Many modifications and other embodiments will come to mind to one skilled in the art to which the invention pertains having the benefit of the teachings presented in the foregoing descriptions and the associated drawings. For example, it is contemplated that the clamping devise may be tightened into a closed position from above the panel array for some applications, whereby the clamp rails may be closed tightly against a row of adjacent panels from above, instead of from below the panels. Therefore, it is to be understood that the invention shall not be limited in any way to the specific embodiments disclosed herein or modifications thereof, and that modifications and other embodiments are intended and contemplated to be included within the scope of the appended claims. Although specific terms are employed herein, they are used in a generic and descriptive sense only and not for purposes of limitation.

What is claimed is:

1. A method of making a carbonated protein beverage composition, comprising:
flowing a liquid protein concentrate;
flowing water;
mixing the flowing liquid protein concentrate with the flowing water to form a beverage composition pre-mix;
sensing the temperature of the pre-mix;
controlling water temperature of the flowing water prior to mixing with the flowing protein concentrate in response to changes in the sensed pre-mix temperature to maintain a substantially constant temperature of the beverage composition pre-mix;
admixing carbonation to the temperature controlled pre-mix to form the carbonated protein beverage composition; and
containerizing the carbonated protein beverage composition.

2. A method of claim 1, wherein the liquid protein concentrate has a weight percentage of between about 20% and about 22% actual protein.

3. A method of claim 1, wherein the liquid protein concentrate has a temperature of between about 2° C. and about 5° C.

4. A method of claim 1, wherein the liquid protein concentrate has a pH between about 2.8 and about 3.1.

5. A method of claim 1, wherein the liquid protein concentrate is a syrup.

6. A method of claim 1, wherein the flowing liquid protein concentrate and water are introduced into a mixing tank at or near the interior side walls thereof, and admixing ingredients to the mixing tank.

7. A method of claim 1, further including mixing the flowing liquid protein concentrate and water in a mixing tank, and snifting oxygen therefrom.

8. A method of claim 6 or claim 7, wherein the mixing tank includes an inwardly tapered section.

9. A method of claim 1, further including sensing the pH of the pre-mix, and controlling the pH of the pre-mix in response to the sensed pH being out of a given pH range.

10. A method of claim 1, further including sensing the quantity of protein in the pre-mix, and controlling the quantity of flowing liquid protein concentrate mixing with the flowing water in response to the sensed protein being out of a given protein range.

11. A method of claim 1, further including sensing the hardness of the flowing water, and controlling the hardness of the flowing water in response to the sensed hardness being out of a given hardness range.

12. A method of claim 1, wherein the resulting carbonated protein beverage has a by weight concentration of between about 0.01% and about 15% protein.

13. A method of claim 12, wherein the protein is one or more of the group consisting of whey protein, casein, lactalbumin, serum albumin, glycomacropeptide, soy protein, rice protein, pea protein, canola protein, wheat protein, hemp protein, zein, flax protein, egg white protein, ovalbumin, gelatin protein, and combinations thereof.

14. A method of claim 1, wherein the resulting carbonated protein beverage has a pH of between about 2.0 and 5.5.

15. A method of claim 1, wherein the resulting carbonated protein beverage contains between about 1.0 volumes per liter and 6.0 volumes per liter.

16. A method of claim 1, wherein the resulting carbonated protein beverage is capable of having an unrefrigerated shelf life of at least one year.

17. A method of making a carbonated protein beverage composition, comprising:
flowing a liquid protein concentrate;
flowing water;
mixing the flowing liquid protein concentrate with the flowing water to form a beverage composition pre-mix;
sensing the pH of the pre-mix;
controlling the pH of the pre-mix in response to the sensed pH being out of a given pH range;
admixing carbonation to the pre-mix; and
containerizing the carbonated protein beverage composition.

18. A method of making a carbonated protein beverage composition, comprising:
flowing a liquid protein concentrate;
flowing water;
mixing the flowing liquid protein concentrate with the flowing water to form a beverage composition pre-mix;
sensing the quantity of protein in the pre-mix;
controlling the quantity of the flowing liquid protein concentrate mixing with the flowing water in response to the sensed protein being out of a given protein range;
admixing carbonation to the pre-mix; and
containerizing the carbonated protein beverage composition.

19. A method of making a carbonated protein beverage composition, comprising:
flowing a liquid protein concentrate;
flowing water;
mixing the flowing liquid protein concentrate with the flowing water to form a beverage composition pre-mix;
sensing the hardness of the flowing water;
controlling the hardness of the flowing water in response to the sensed hardness being out of a given hardness range;
admixing carbonation to the pre-mix; and
containerizing the carbonated protein beverage composition.

20. A system for making a carbonated protein beverage composition, comprising:
a mixing tank for combining flowing liquid protein concentrate and flowing water to provide a pre-mix, the tank having interior side walls;
a manifold for receiving the flowing protein concentrate and water and introducing them at or near the interior side walls;
slow speed paddles for gently mixing the flowing protein concentrate and flowing water;
a gas injector for carbonating the pre-mix; and
containerization apparatus for containerizing the carbonated protein beverage composition.

21. A system of claim 20, further including high speed paddles.

22. A system of claim 21, further including a pair of motors for separately driving the low and high speed paddles.

23. A system of claim 20, wherein the tank includes a frustoconical section and wherein the interior side walls are inwardly tapered.

24. A system of claim 20, further including an oxygen sensor for sensing oxygen in the pre-mix, and a snifting release valve for permitting oxygen to be released from the tank.

25. A system of claim 20, wherein the tank is sealed and heat insulated.
